(19) United States
(12) Patent Application Publication
(10) Pub. No.: US 2009/0148658 A1
(43) Pub. Date: Jun. 11, 2009

(54) Sealing arrangement composed of different types of polymer material

(75) Inventors: Holger Gutschmidt, Neu Wulmstorf (DE); Heiko Hoft, Rosengarten (DE); Andreas Diener, Seevetal (DE)

Correspondence Address: COLLARD & ROE, P.C., 1077 NORTHERN BOULEVARD, ROSLYN, NY, 11576, US

(73) Assignee: PHOENIX DICHTUNGSTECHNIK GMBH, Waltershausen (DE)

(21) Appl. No.: 11/989,083

(22) PCT Filed: Aug. 18, 2005
(86) PCT No.: PCT/DE2005/001459

§ 371 Date: Jan. 18, 2008

(51) Int. Cl. C09K 3/10

(52) U.S. Cl. 428/131

(57) ABSTRACT

The invention relates to a sealing arrangement composed of at least: two adjoining structural parts (2) made of concrete, steel, reinforced concrete, cast iron or other materials, and a sealing profile (8) which is made of polymer material and sealingly bridges the gap (4) between the two structural parts (2). The sealing arrangement according to the invention is characterized in that: the sealing profile (8) is composed of two or more co-extruded sealing parts (A1, B1) that form an adhesive join, the sealing parts being produced using at least two different types of polymer materials that are distinguished by having common elastic properties but having different mechanical and/or chemical and/or biological properties. Advantageous co-extruded sealing part constructions and material combinations are proposed.

The invention relates to a sealing arrangement, comprising at least:
two components that abut one another, made of concrete, steel, steel-reinforced concrete, cast iron, or other materials (e.g. synthetic resins), as well as of a sealing profile made of polymer material, which bridges the gap between the two components, forming a seal;
whereby the components are segments that are joined together to form a tubular tunnel, specifically with the formation of a gap system in the form of crosswise and lengthwise joins, whereby each segment is provided, at its abutment side, preferably with at least one circumferential recess that covers all of the segment abutment sides, whereby in turn, a sealing profile that runs in the form of a strand is situated in each recess, specifically with the formation of a sealing frame with frame corners, whereby the sealing profile is provided with open and/or closed grooves that run in the form of a strand and are disposed on the profile base side, as well as with channels that also run in the form of a strand and are disposed between the grooves and the profile face side.

Since the segments possess four abutment sides, in most instances, the sealing frame consists of four joined sealing profiles, whereby the frame corners are preferably produced according to the injection-molding principle (EP 0 578 797 B1, EP 1 141 594 B1).

A sealing arrangement of the type stated is known, for example, from U.S. Pat. No. 4,946,309, EP 0 441 250 B1, and EP 0 995 013 B1. As a result of the components or segments that abut one another being pressed together, thereby reducing the distance of the gap, i.e. the crosswise and lengthwise joins, the sealing profile made of elastomer material then develops its sealing effect, under the interaction of force and reaction force. Such compression seals have proven themselves in numerous tunnel projects.

Up to the present, such sealing profiles have been produced by means of mono-extrusion, specifically on the basis of a uniform material concept.

Within the framework of a further development, the task of the invention consists in making available a sealing arrangement, whereby the material selection of the sealing profile can be adapted in accordance with the requirements in the interior and the exterior of the tunnel construction.

This task is accomplished, according to the characterizing part of claim 1, in that the sealing profile consists of two or more co-extruded sealing parts, which form an adhesive connection, whereby at least two different types of polymer materials are used for the sealing parts, which are characterized by having elastic properties in common, but otherwise having different mechanical and/or chemical and/or biological properties.

Practical embodiments of the invention are named in claims 2 to 26.

The invention will now be explained using exemplary embodiments, making reference to schematic drawings. These show:

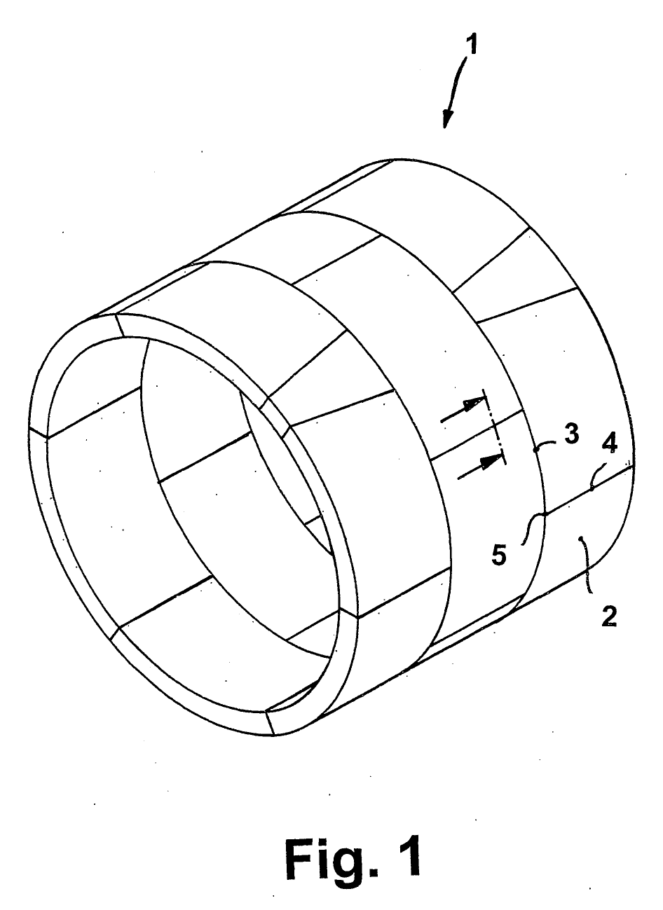

FIG. 1 a tunnel consisting of segments as well as lengthwise and crosswise joins;

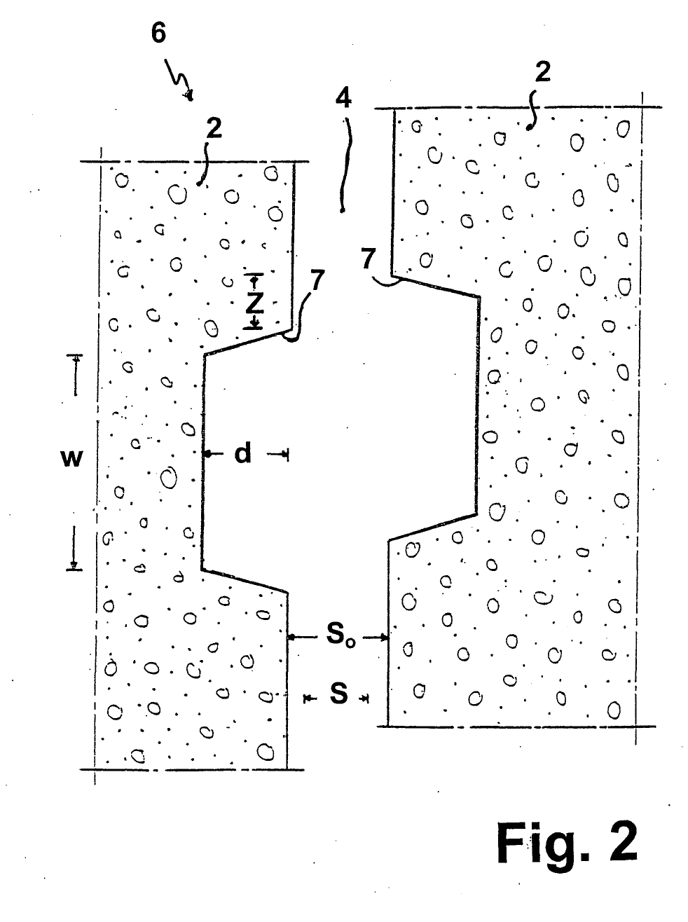

FIG. 2 a sealing arrangement with the gap of two adjacent tunnel segments to be sealed, according to the section line (FIG. 1);

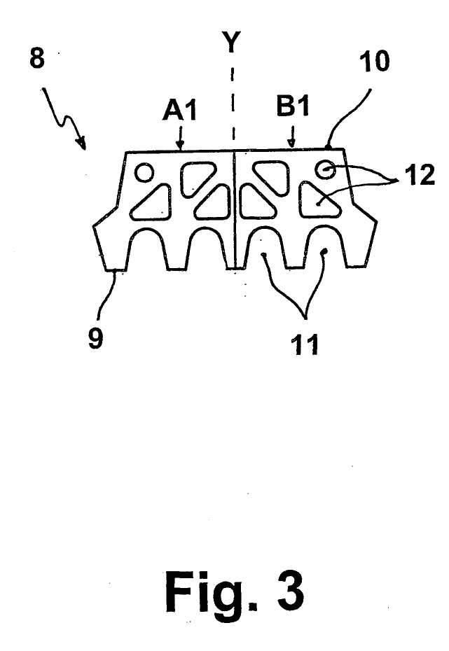

FIGS. 3, 4, 5 sealing profiles having two co-extruded sealing parts;

FIGS. 6, 7 sealing profiles having three co-extruded sealing parts;

FIGS. 8, 9 sealing profiles having more than three co-extruded sealing parts

FIG. 1 shows a tunnel 1, consisting of segments 2, specifically with the formation of crosswise and lengthwise joins 3 and 4, respectively, as well as a T abutment arrangement 5.

FIG. 2 shows a sealing arrangement 6 with two tunnel segments 2 that abut one another, made of concrete, which are each provided with a recess 7 (depth d, base width w). Sealing profiles made of polymer material having elastic properties are now inserted into these two recesses, whereby reference is made to the examples according to FIGS. 3 to 9, which will be explained in greater detail below. The actual sealing of the gap (here in the form of the lengthwise join 4) takes place by means of compression of the opposite sealing profiles (compression seal), whereby the gap distance is reduced from Sₒ to S. In this connection, in the construction of tunnels, it must be taken into consideration that the segments 2 are disposed at an offset Z with regard to one another. In this connection, the sealing profiles are expected to develop their sealing effect even under this tunnel-specific criterion. In this regard, numerous high-performance seals have already been developed, whereby reference is made, for example, to the prior art cited initially. A tunnel seal that is used with particular frequency is described in the patent EP 0 441 250 B1.

FIG. 3 now shows a sealing profile 8 made of a polymer material, comprising a profile base side 9 that corresponds to the recess width w (FIG. 2), and a profile face side 10 that projects beyond the recess depth d (FIG. 2). The sealing profile is provided with open grooves 11 that run in the form of a strand, as well as with channels 12 that also run in the form of a strand, which are disposed on two rows (EP 0 441 250 B1).

The sealing profile consists of two co-extruded sealing parts A1 and B1, which form an outside profile segment and an inside profile segment that are of equal size, with reference to the longitudinal profile plane Y that runs perpendicular to the profile base side 9 and the profile face side 10, respectively.

Elastomers on the basis of chloroprene (CR), nitrile rubber (NBR), styrene butadiene rubber (SBR), an ethylene-propylene-diene mixed polymerizate (EPDM), or blends of them (e.g. NBR/SBR) can be used for the two sealing parts A1 and B1. Advantageous elastomer combinations are contained in Table 1.

TABLE 1

| Sealing part A1 or B1 | Sealing part B1 or A1 |
|---|---|
| CR | EPDM |
| NBR | EPDM |
| SBR | EPDM |
| CR | NBR |
| CR | SBR |
| NBR | SBR |

In this connection, this is a vulcanized rubber mixture, whereby the rubber or blend components mentioned above generally occur in a proportion of 30 to 70 wt.-%, in each instance. The rubber mixture has a cross-linking agent or cross-linking agent system. In this connection, the cross-linking agent system comprises a cross-linking agent and/or vulcanization activator, as well as an accelerator. Other usual mixture ingredients, which can be used individually or, particularly, in combination, are fillers, processing aids, plasticizers, anti-aging agents, and stabilizers. In this regard, reference is made to the general state of rubber mixture technology.

Aside from the good elastic properties of all of these materials (CR, NBR, SBR, EPDM), they are also characterized by individual criteria, namely flame resistance (CR), friction-wear resistance (SBR), weathering resistance (EPDM), as well as swelling resistance with regard to oils, greases, and fuels (NBR).

The following material combinations according to Table 2 can also be used.

TABLE 2

| Sealing part A1 or B1 | Sealing part B1 or A1 |
|---|---|
| TPE | TPE |
| elastomer | TPE |
| TPE | elastomer |

Here again, CR, NBR, SBR, EPDM or blends of them are a practical basis for the elastomers.

As far as the TPE groups are concerned, thermoplastic elastomers on a styrene basis (TPE-S), non-cross-linked or partially cross-linked thermoplastic elastomers on an olefin basis (TPE-o), or fully cross-linked thermoplastic elastomers on an olefin basis (TPE-V) are preferably used. To the extent that cross-linking is present, which is usually the case, the essential component of the mixture ingredients is the cross-linking agent or the cross-linking agent system. The other mixture ingredients can comprise all the raw material components that have a positive influence on the property profile of the TPE material. These are, for example, fillers, anti-aging agents, stabilizers, flow aids, and processing aids. In this regard, reference is made to the general state of TPE technology.

A TPE material that consists of a blend of a thermoplastic plastic (thermoplastic) and an at least partially cross-linked rubber, particularly on the basis of EPDM is of particular significance. The plastic that is preferably used is a polypropylene on the basis of a homopolymer, copolymer, or block copolymer. The rubber has a degree of cross-linking of >90%, in particular, whereby a plasticizer is used to stretch the rubber. In other regards, the TPE mixture ingredients mentioned above apply here, as well. With regard to details (e.g. amount proportions within the TPE mixture) of this preferred TPE material, reference is made to the document DE 103 36 424 A1.

Within the framework of a more recent development, a surface modifier is additionally mixed into the TPE materials; it migrates uniformly to the surface, specifically with the formation of a continuous, wax-like, solid layer (DE 103 36 424 A1). This layer is smooth and allows simple assembly of seals, because of the low friction coefficient.

Furthermore, it is known to mix an active inhibitor into the polymer materials, particularly the elastomer materials, which prevents the growth of microorganisms. This microbe-resistant material having biological properties is of importance in the case of sealing profiles in contact with water. In this regard, particular reference is made to the document DE 102 58 551 A1, which concerns itself with a microbe-resistant settling basin membrane. The microbe resistance of polymer materials is gaining importance.

Furthermore, different hardness values of the individual sealing parts A1 and B1 are also possible, in order to achieve the desired material properties. In this connection, the hardness values can vary between 50 and 90° Shore. However, it is also possible that the two co-extruded sealing parts possess the same hardness, as is usually the case for the exemplary embodiment according to FIG. 3.

With reference to the sealing profile 8 according to FIG. 3, the following two examples are mentioned with the background of the material technology presented in greater detail above, whereby the sealing part A1 faces the exterior region of the tunnel, and the sealing part B1 faces the interior region of the tunnel, in each instance.
If the tunnel leads underground through an industrial region, it is practical if the sealing part A1 is produced on the basis of the oil-resistant material NBR, while a material on the basis of CR, SBR, or EPDM is used for the other sealing part B1.
The tunnel forms a crossing under a river, so that the sealing part A1, in contrast to the sealing part B1, is microbe-resistant, specifically on the basis of the same material (e.g. EPDM) or two different materials (Table 1).

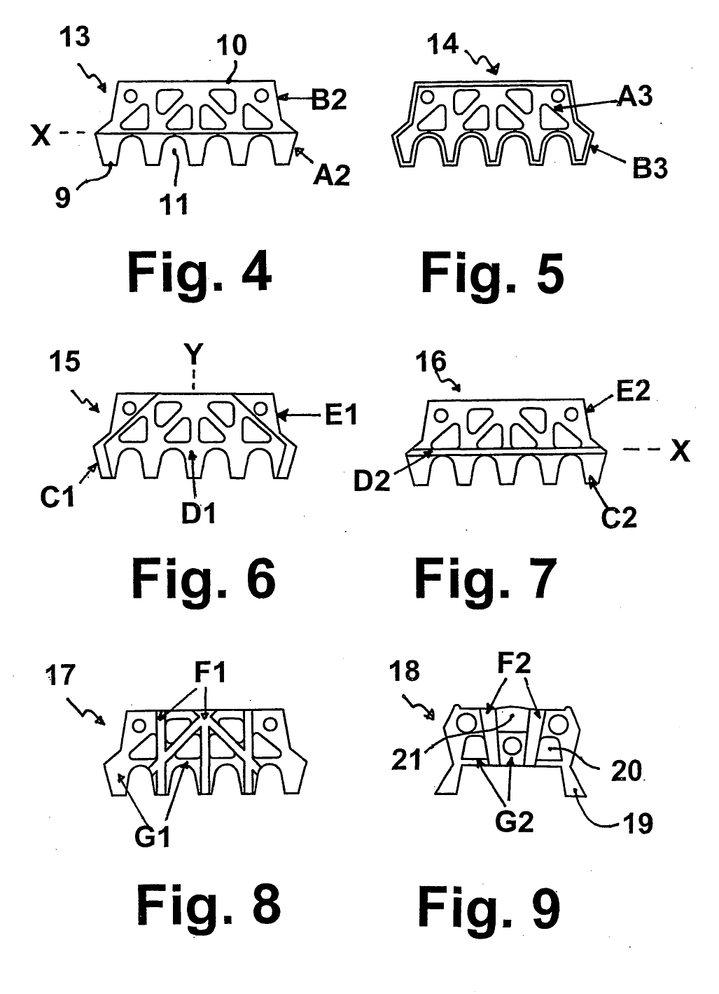

FIG. 4 shows a sealing profile 13 having two sealing parts A2 and B2, which form a base-side and face-side profile segment with reference to the longitudinal profile plane X, which runs parallel to the profile base side 9 and the profile face side 10, respectively. In this connection, the base-side profile segment exclusively covers the open grooves 11.

In the case of a sealing profile having such a structure, it is an option to equip the face-side sealing part B2 with a TPE material, into which a surface modifier is mixed, in order to facilitate assembly. The base-side sealing part A2, on the other hand, consists of an elastomer material on the basis of CR, NBR, SBR, or EPDM.

FIG. 5 shows a sealing profile 14 having the sealing parts A3 and B3, specifically with the formation of a profile core segment and profile sleeve segment. In this connection, the profile sleeve segment (sealing part B3), which completely surrounds the profile core segment, (sealing part A3), has a lesser thickness as compared with the profile core segment, whereby preferably, the minimum thickness is 2 mm.

In the case of a sealing profile according to FIG. 5, it is an option to exclusively equip the sleeve-shaped sealing part B3 to be oil-resistant or microbe-resistant. Furthermore, the sealing part B3 can be produced from a harder material, so that in this way, the seal becomes statically more stable. As a result, the forces that act on the seal can be better counteracted by means of the compression.

According to FIG. 6, the sealing profile 15 consists of three co-extruded sealing parts C1, D1, and E1, which form two profile edge segments and a profile interior segment, with reference to the longitudinal profile plane Y, which runs perpendicular to the profile base side and the profile face side, respectively, whereby the two profile edge segments are of equal size. In this connection, it is sufficient if exclusively two different types of polymer materials are used, namely a uniform material for the two sealing parts C1 and E1.

In the case of a sealing profile according to FIG. 6, it is also an option to equip exclusively the two edge sealing parts C1 and E1 to be oil-resistant or microbe-resistant, for example. Here, too, it is possible to produce the two edge sealing parts from a harder material, specifically for the purpose of stabilizing the seal.

FIG. 7 also shows a sealing profile 16 having three co-extruded sealing parts C2, D2, and E2, which form a base-side and face-side profile segment, with reference to the longitudinal profile plane X that runs parallel to the profile base side and the profile face side, respectively, whereby a profile strut that is continuous and runs straight is disposed between these two profile segments. The profile strut preferably has a minimum thickness of 2 mm.

The sealing parts C2 and E2 consist of the same material, specifically in contrast to the profile strut (sealing part D2). In the case of such a sealing profile structure, it is an option, for example, to make the profile strut harder (60 to 90° Shore) than the two other sealing parts C2 and E2 (50 to 80° Shore).

The sealing profiles 17 and 18 according to FIGS. 8 and 9 have more than three co-extruded sealing parts, formed from a profile strut system F1 (FIG. 8) and F2 (FIG. 9), respectively, and a multi-part profile base system G1 (FIG. 8) and G2 (FIG. 9), respectively, the individual profile segments of which are separated from one another by means of the strut formation. Here, it is of particular significance to equip the profile strut system to be harder than the profile base system, whereby the individual struts, in turn, preferably have a minimum thickness of 2 mm. Such a material differentiation leads to a sealing profile having a particularly great sealing performance, particularly in combination with a frame-like strut system F1 according to FIG. 8.

The sealing part 18 according to FIG. 9 is additionally equipped with two anchoring feet 19 (DE 39 34 198 C2). Here, the grooves 20 are closed, in contrast to the sealing profiles according to FIGS. 3 to 8. The profile region 21 can furthermore be equipped with an accommodation groove for a swelling seal (emergency seal). In this regard, reference is made, for example, to the two patents EP 0 807 B1 and EP 0 811 113 B1.

The adhesive connection between the co-extruded sealing parts, as they are shown in FIGS. 3 to 9, for example, is formed within the framework of co-extrusion, under temperature and pressure.

### REFERENCE SYMBOL LIST

1 tunnel
2 segment
3 crosswise join (ring join)
4 lengthwise join
5 T abutment arrangement
6 sealing arrangement
7 recess
8 sealing profile
9 profile base side
10 profile face side
11 grooves
12 channels
13 sealing profile
14 sealing profile
15 sealing profile
16 sealing profile
17 sealing profile
18 sealing profile
19 anchoring foot
20 closed grooves
21 profile region with accommodation grooves for swelling seal
A1, A2, A2 co-extruded sealing parts
B1, B2, B3 co-extruded sealing parts
C1, C2 co-extruded sealing parts
D1, D2 co-extruded sealing parts
E1, E2 co-extruded sealing parts
F1, F2 co-extruded sealing parts
G1, G2 co-extruded sealing parts
X, Y longitudinal profile planes
Z segment offset
Sₒ gap distance (before compression)
S gap distance (after compression)
d depth of the recess
w base width of the recess

1: Sealing arrangement (6), comprising at least:
two components that abut one another, made of concrete, steel, steel-reinforced concrete, cast iron, or other materials, as well as of a sealing profile made of polymer material, which bridges the gap between the two components, forming a seal;
whereby the components are segments (2) that are joined together to form a tubular tunnel (1), specifically with the formation of a gap system in the form of crosswise and lengthwise joins (3, 4), whereby each segment is provided, at its abutment side, preferably with at least one circumferential recess (7) that covers all of the segment abutment sides, whereby in turn, a sealing profile (8, 13, 14, 15, 16, 17, 18) that runs in the form of a strand is situated in each recess, specifically with the formation of a sealing frame with frame corners, whereby the sealing profile is provided with open and/or closed grooves (11, 20) that run in the form of a strand and are disposed on the profile base side (9), as well as with channels (12) that also run in the form of a strand and are disposed between the grooves and the profile face side (10);
wherein
the sealing profile (8, 13, 14, 15, 16, 17, 18) consists of two or more co-extruded sealing parts, which form an adhesive connection, whereby at least two different types of polymer materials are used for the sealing parts, the polymer materials having elastic properties in common, but otherwise having different mechanical and/or chemical and/or biological properties.

2: Sealing arrangement according to claim 1, wherein two co-extruded sealing parts (A1, B1) are present, which form an outside profile segment and an inside profile segment, with reference to the longitudinal profile plane Y that runs perpendicular to the profile base side (9) and the profile face side (10), respectively, whereby the two profile segments are particularly of equal size.

3: Sealing arrangement according to claim 1, wherein two co-extruded sealing parts (A2, B2) are present, which form a base-side profile segment and a face-side profile segment, with reference to the longitudinal profile plane X that runs parallel to the profile base side (9) and the profile face side (10), respectively.

4: Sealing arrangement according to claim 3, wherein the base-side profile segment exclusively covers the open and/or closed grooves (11, 20).

5: Sealing arrangement according to claim 1, wherein two co-extruded sealing parts (A3, B3) are present, specifically with the formation of a profile core segment and profile sleeve segment, whereby preferably, the profile sleeve segment completely surrounds the profile core segment.

6: Sealing arrangement according to claim 1, wherein three co-extruded sealing parts (C1, D1, E1) are present, which form two profile edge segments and a profile interior segment, with reference to the longitudinal profile plane Y, which runs perpendicular to the profile base side (9) and the profile face side (10) respectively, whereby the two profile edge segments, in particular, are of equal size.

7: Sealing arrangement according to claim 1, wherein three co-extruded sealing parts (C2, D2, E2) are present, which form a base-side and face-side profile segment, with reference to the longitudinal profile plane X that runs parallel to the profile base side (9) and the profile face side (10), respectively, whereby a profile strut that is continuous and runs straight is disposed between these two profile segments.

8: Sealing arrangement according to claim 1, wherein more than three co-extruded sealing parts (F1, F2, G1, G2) are present, formed from a profile strut system (F1, F2) and a multi-part profile base system (G1, G2), the individual profile segments of which are separated from one another by means of the strut formation.

9: Sealing arrangement according to claim 6, wherein in the case of three or more than three co-extruded sealing parts, exclusively two different polymer material types are used, which are characterized by having elastic properties in common, but otherwise having different mechanical and/or chemical and/or biological properties.

10: Sealing arrangement according to claim 1, wherein different types of polymer materials, which are exclusively elastomers, are used.

11: Sealing arrangement according to claim 10, wherein elastomers on the basis of chloroprene (CR), nitrile rubber (NBR), styrene butadiene rubber (SBR), an ethylene-propylene-diene mixed polymerizate (EPDM), or blends of them are used.

12: Sealing arrangement according to claim 11, wherein the two elastomers CR and EPDM are used in combination.

13: Sealing arrangement according to claim 11, wherein the two elastomers NBR and EPDM are used in combination.

14: Sealing arrangement according to claim 11, wherein the two elastomers SBR and EPDM are used in combination.

15: Sealing arrangement according to claim 11, wherein the two elastomers CR and NBR are used in combination.

16: Sealing arrangement according to claim 11, wherein the two elastomers CR and SBR are used in combination.

17: Sealing arrangement according to claim 11, wherein the two elastomers NBR and SBR are used in combination.

18: Sealing arrangement according to claim 1, wherein different types of polymer materials, which are exclusively thermoplastic elastomers (TPE), are used.

19: Sealing arrangement according to claim 18, wherein thermoplastic elastomers (TPE) on a styrene basis (TPE-S), non-cross-linked or partially cross-linked thermoplastic elastomers on an olefin basis (TPE-o), or fully cross-linked thermoplastic elastomers on an olefin basis (TPE-V) are used.

20: Sealing arrangement according to claim 18, wherein thermoplastic elastomers (TPE) on the basis of a blend of a thermoplastic plastic and an at least partially cross-linked rubber, particularly on the basis of an ethylene-propylene-diene mixed polymerizate (EPDM) are used.

21: Sealing arrangement according to claim 1, wherein elastomers and thermoplastic elastomers are used in combination.

22: Sealing arrangement according to claim 1, wherein the co-extruded sealing parts have the same Shore hardness.

23: Sealing arrangement according to claim 1, wherein the co-extruded sealing parts have different Shore hardness values.

24: Sealing arrangement according to claim 1, wherein at least the sealing part facing the water side is microbe-resistant.

25: Sealing arrangement according to claim 1, wherein the co-extruded sealing part having the least thickness has a minimum thickness of ≧2 mm.

26: Sealing arrangement according to claim 1, wherein the adhesive connection between the co-extruded sealing parts is formed within the framework of co-extrusion, under temperature and pressure.
